(19) United States
(12) Patent Application Publication
(10) Pub. No.: US 2017/0168252 A1
(43) Pub. Date: Jun. 15, 2017

(54) OPTICAL TRANSCEIVER WITH COMBINED TRANSMITTER AND RECEIVER ASSEMBLY

(71) Applicant: Kaiam Corp., Newark, CA (US)

(72) Inventors: Bardia Pezeshki, Menlo Park, CA (US); John Heanue, Boston, MA (US)

(21) Appl. No.: 15/373,991

(22) Filed: Dec. 9, 2016

Related U.S. Application Data
(60) Provisional application No. 62/311,303, filed on Mar. 21, 2016.
(60) Provisional application No. 62/265,933, filed on Dec. 10, 2015.

(51) Int. Cl. G02B 6/42; H04B 10/40; H04J 14/02; G02B 6/43; G02B 6/12

(52) U.S. Cl. CPC G02B 6/4246; G02B 6/43; G02B 6/4285; G02B 6/4256; G02B 6/12019; G02B 6/4214; G02B 6/4226; H04J 14/0227; H04B 10/40

(57) ABSTRACT

An optical transceiver assembly includes a circuit board and a PLC, both performing transmission and reception functions, in a common volume of a common housing, electro-optical conversion elements, for example lasers and/or photodetectors. Lasers may be on a further substrate on the circuit board.

### CROSS REFERENCE TO RELATED APPLICATIONS

This application claims the benefit of the filing date of U.S. Provisional Patent Application No. 62/265,933, filed on Dec. 10, 2015, and U.S. Provisional Patent Application No. 62/311,303, filed on Mar. 21, 2016, the disclosures of which are incorporated by reference herein.

### BACKGROUND OF THE INVENTION

The present invention relates generally to optical transceivers, and more particularly to an optical transceiver with a combined transmitter and receiver assembly.

Optical transceivers are generally used in optical communication systems. These optical communication systems may be used in a variety of communications applications. For example, long-haul communications systems may use optical fibers in communicating information over great lengths. Similarly, within data centers optical communications may be used to communicate information between servers. For data centers, any given data center may include a large number of servers, and in turn each server may have a large number of optical communication links.

Generally the optical communication links are provided by optical fibers, with an optical transceiver at each end of the fiber. Often any particular fiber may be coupled to an optical transmitter of the optical transceiver at one end of the particular fiber, and coupled to an optical receiver of the optical transceiver at an opposing end of the particular fiber. While each fiber may include data paths for multiple communication signals, for example using either dense-wavelength division multiplexing (DWDM) or coarse-wavelength division multiplexing (CWDM), allowing for several sets of communication signals on any one fiber, in many cases each particular computer unit will have many more communications links than may be provided by any single fiber or pair of fibers. Each particular computer unit, whether a server, router, switch or other device, will therefore generally include multiple optical transceivers. For the case of data centers, for example, each particular computer unit may have tens or even hundreds of optical transceivers.

Optical transceivers generally include a receiver optical subassembly (ROSA), a transmitter optical subassembly (TOSA), and a circuit board including various semiconductor circuits. The ROSA generally demultiplexer the multiple optical signals received from an optical fiber and converts optical signals to electrical signals, with the electrical signals provided to circuitry on the circuit board for further processing. The TOSA generally receives electrical signals from circuitry on the circuit board, converts the electrical signals to optical signals, and multiplexes the optical signals into another optical fiber.

The ROSA and TOSA are generally provided each in their own separate housing, with the ROSA and TOSA housings placed within a housing or tray for the optical transceiver as a whole. The ROSA and TOSA are connected to the circuit board of the optical transceiver using a flexible printed circuit board (FPC), which allows for some relative movement between the ROSA and TOSA and the circuit board.

Unfortunately, having the ROSA and TOSA in separate housings and the use of the FPC may result in increased cost of deployment of optical transceivers. In addition, the use of the FPC may provide difficulties in practice.

### BRIEF SUMMARY OF THE INVENTION

One aspect of the invention is an optical transceiver assembly, comprising: a substrate; a circuit board fixedly coupled to the substrate and configured to process and provide electrical signals; a plurality of lasers with output light modulated in accordance with at least some of the electrical signals; a planar lightwave circuit (PLC) fixedly coupled to the substrate, the PLC including an optical demultiplexer having an input and a plurality of outputs and an optical multiplexer having a plurality of inputs to receive light from the lasers and an output; and an input optical fiber coupled to the demultiplexer input of the PLC and an output optical fiber coupled to the multiplexer output of the optical fiber.

These and other aspects of the invention are more fully comprehended upon review of this disclosure.

### BRIEF DESCRIPTION OF THE FIGURES

FIG. 1 shows portions of an optical transceiver in accordance with aspects of the invention.

FIG. 2 shows a close-up view of portions of optical transceiver of FIG. 1.

FIG. 3 shows an example of a PLC in accordance with aspects of the invention.

FIG. 4 shows an MEMS assembly having lasers coupled to a PLC in accordance with aspects of the invention.

FIG. 5 shows an exploded view of an optical transceiver in accordance with aspects of the invention.

FIG. 6 shows portions of the optical transceiver of FIG. 5.

FIG. 7 shows a close up perspective view of some of the components of the optical transceiver of FIG. 5.

FIG. 8 shows a close up top view of some of the components of the optical transceiver of FIG. 5.

FIG. 9 shows a further view of some of the components of the optical transceiver of FIG. 5.

FIG. 10 shows portions of a further optical transceiver in accordance with aspects of the invention.

FIG. 11 shows portions of the further optical transceiver of FIG. 10, with a first submount installed.

FIG. 12 shows portions of the further optical transceiver of FIG. 10, with the first submount installed and a second submount installed.

FIG. 13 shows a layout of a further PLC useful in aspects of the invention.

### DETAILED DESCRIPTION

In some embodiments an optical transceiver includes a circuit board and a planar lightwave circuit (PLC) fixed in position to a common carrier, for example a common substrate or a common metal plate. The PLC includes both an optical multiplexer and an optical demultiplexer. Inputs of the multiplexer are coupled to outputs of laser diodes, with an output of the multiplexer coupled to an output optical fiber, which is a first fiber pigtail in many embodiments. An input of the demultiplexer is coupled to an input optical fiber, which is a second fiber pigtail in many embodiments, with outputs of the demultiplexer coupled to photodiodes. In some embodiments one or both of the multiplexer and demultiplexer are comprised of arrayed waveguide gratings (AWG).

In some embodiments the first and second fiber pigtails are coupled to first and second capillary structures, respectively, with the first and second capillary structures mounted, in some embodiments glued, to the PLC. In many embodiments the first and second fiber pigtails have a length slightly greater than a length sufficient to allow for connection of the capillary structure and a receptacle at a front panel of the optical transceiver, to allow for increased compliance between the structure including the PLC and a structure including the receptacle at the front panel.

In some embodiments outputs of lasers, for example between portions of the circuit board and the PLC, are coupled to the PLC by lenses mounted on one or more moveable stages. In some embodiments the moveable stages are microelectromechanical structures (MEMS). In some embodiments optical isolators are in an optical path between the lasers and the PLC.

In some embodiments outputs of the photodiodes are coupled to transimpedance amplifier (TIA) circuitry. In some embodiments the TIA circuitry is in a semiconductor chip mounted to a common substrate carrying the MEMS. In some embodiments the common substrate is also connected to either or both of the circuit board and/or the PLC.

In some embodiments semiconductor circuitry on the circuit board chips mounted to the circuit board using chip-on-board technology. In some embodiments the circuitry includes driver circuitry for providing drive signals carrying data to the lasers, which may be directly driven by the drive signals carrying data. In some embodiments the lasers are driven in a continuous wave manner, with the drive signals used to modulate light output from the lasers, for example using a modulator such as a Mach-Zehnder modulator. In some embodiments the circuitry includes clock and data recovery (CDR) circuitry, for example to reclock received data. In some embodiments a chip including the driver circuitry additionally includes (CDR) circuitry.

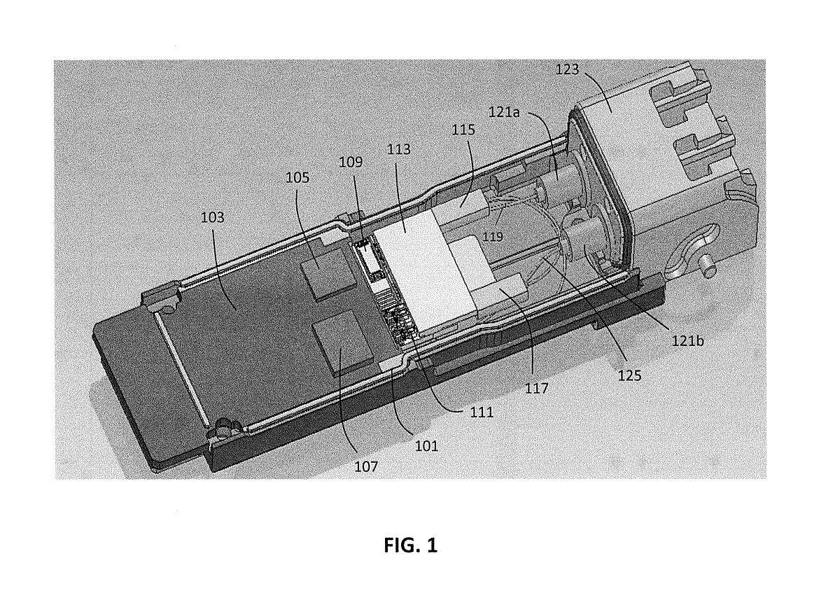

FIG. 1 shows portions of an optical transceiver in accordance with aspects of the invention. The optical transceiver includes a circuit board 103 and a planar lightwave circuit (PLC) 113 both mounted to a common substrate 101, for example a metal plate. In some embodiments the circuit board and PLC are directly mounted to the common substrate, but in many embodiments one or both of the circuit board are mounted fixedly, but indirectly, to the common substrate. The circuit board and PLC are configured to perform both transmission and reception functions for the optical transceiver.

With respect to the reception function, input light which carries input data may travel, on an optical fiber through a case front 123 to a receptacle 121a. The receptacle passes the light to an input fiber pigtail 119, which in turn pass the light or input data to capillary structure 115. The fiber pigtail generally serves to provide compliance, e.g., tolerance level, between a front of the case and the capillary structure, which may be glued or otherwise fixedly attached to or part of the PLC.

The input data may come in various wavelength lanes by way of the input fiber. Light from the input fiber may be demultiplexed, for example on a wavelength selective basis, by the PLC into separate waveguides. The PLC may direct light in the waveguides into input photodetectors (not shown), e.g., a photodiode array, which provide electrical signals. The electrical signals are amplified by a transimpedance amplifier (TIA) 109. In some embodiments, the input photodetectors are positioned between the TIA and PLC. In some embodiments the TIA, by way of embedded traces, provides the amplified signals to a clock and data recovery (CDR) chip 105 that equalizes and clocks the signals for processing. In some embodiments, the CDR chip is mounted to the circuit board using, for example, chip-on-board technology. In some embodiments, the CDR is used for 100 Gb/s data input.

With respect to the transmission function, driver circuitry of a driver chip 107 generates signals to drive lasers 111 with a data signal. As may be seen in FIG. 1, the lasers are mounted to a further substrate between chips on the circuit board and the PLC. In some embodiments the further substrate is coupled to, and in some embodiments mounted on, a forward area of the circuit board. Outputs from lasers 111 are coupled to input waveguides of the PLC, for example using MEMS coupling. In some embodiments the MEMS include a lens on a movable stage, with the lens movable to a position in which light from the lasers is directed into waveguides of the PLC. In some embodiments the MEMS structure is for example as discussed in U.S. patent application Ser. No. 14/621,273 filed on Feb. 12, 2015 entitled PLANAR LIGHTWAVE CIRCUIT ACTIVE CONNECTOR, and/or U.S. Pat. No. 8,346,037 issued on Jan. 1, 2013 entitled MICROMECHANICALLY ALIGNED OPTICAL ASSEMBLY, the disclosures of which are incorporated herein by reference for all purposes. In various embodiments optical isolators are in the optical path between the lasers and the PLC. Accordingly, light from the lasers is coupled to waveguides in the PLC. In some embodiments the waveguides include tips leading to monitor photodiodes, which may be used as part of a feedback loop to adjust laser operating parameters. The PLC multiplexes, in some embodiments using an arrayed waveguide grating (AWG), the light channels into a single output provided to a capillary structure 117. The capillary structure passes the multiplexed light to an output fiber pigtail 125 for transmission. In some embodiments, similar to the CDR chip, the driver chip may also be mounted to the circuit board using chip-on-board technology. In some embodiments, the driver chip may include a built-in CDR unit, for example 100 Gb/s data output.

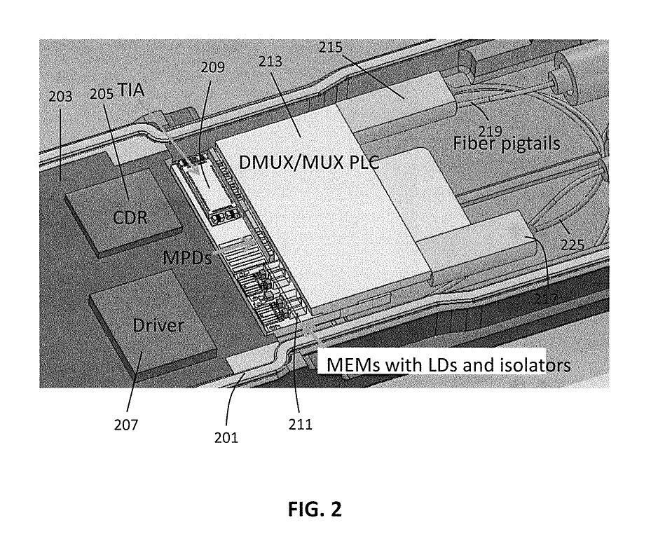

FIG. 2 shows a close-up view of portions of optical transceiver of FIG. 1. As with the architecture of FIG. 1, the architecture of FIG. 2 includes a substrate 201 having a circuit board 203 and a PLC 213 fixedly coupled thereto, with the circuit board and PLC performing both reception and transmission functions.

As previously discussed, with respect to reception, input capillary 215 receives input data by way of input pigtail 219. The PLC may demultiplex light from the input fiber into separate waveguides and provide the light to input photodetectors, which generate electrical signals. The electrical signals are amplified by TIA 209, and in some embodiments equalized and clocked by a CDR 205.

With respect to transmission, lasers 211 are driven by signals from a driver chip 207. Light from the lasers is coupled to the PLC using, for example, a MEMS coupling. In some embodiments, output power from the lasers may be monitored by monitor photodiodes (MPDs) positioned proximate or adjacent to the lasers. The PLC multiplexes the channels (for example using a AWG) into a single output provided to a capillary 217, which in turn passes the single output to an output fiber pigtail 225.

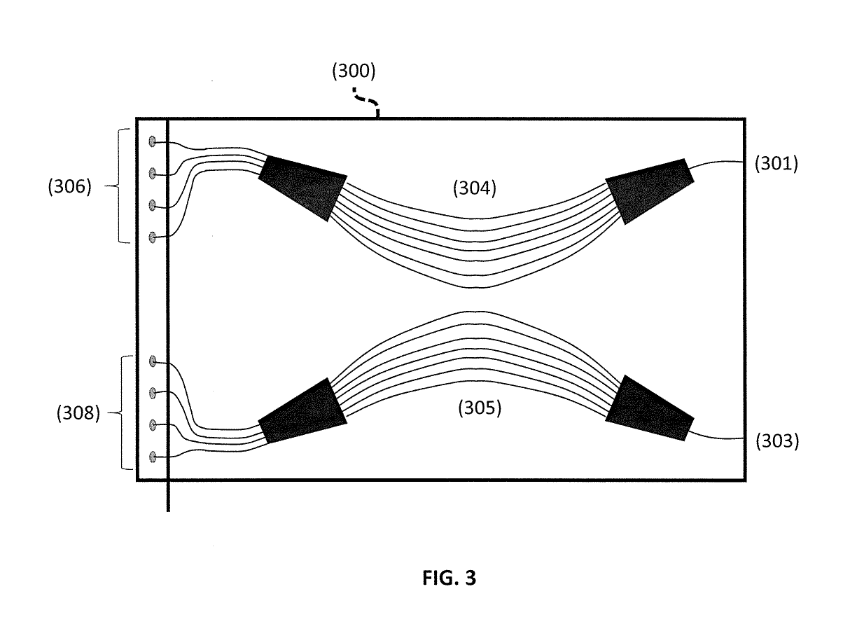

FIG. 3 shows an example of a PLC in accordance with aspects of the invention. Referring to the right side of the figure where a PLC 302 may interface with fibers and lasers, there are two features. The PLC may include an input waveguide 301 for a demultiplexer structure 306. This input waveguide may be aligned and affixed to a capillary structure and fiber pigtail (as previously discussed). The PLC may further include an output waveguide 303 that connects to an output capillary and fiber pigtail (as also previously discussed).

As illustrated in FIG. 3, the PLC includes a demultiplexing AWG 304 and a multiplexing AWG 305. The demultiplexing AWG demultiplexes incoming light into demultiplexer output waveguides 306 that, for example, may be coupled to photodetectors. Multiplexer input waveguides 308 may receive light, for example, from optical modulators or lasers, and the light is multiplexed by the multiplexing AWG. In FIG. 3, AWGs are shown as an example for demultiplexing geometry. Of course, many different kinds of wavelength combiners or splitters may be used. For example, an Eschelle grating provides similar functions. Material of the PLC may be glass on silicon, but in various embodiments a variety of wave materials may instead be used, for example such as silicon-on insulator (SOI) waveguides, polymer waveguides, or higher contrast SiON waveguides. The waveguides and other structures may be on different materials such as Silicon, quartz, or fused-silica.

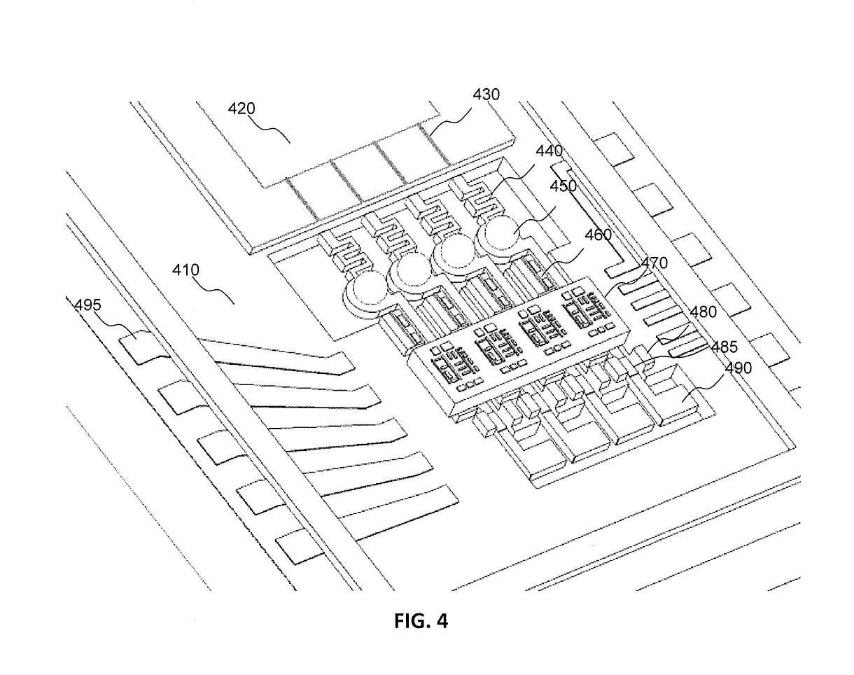

FIG. 4 shows an MEMS assembly having lasers coupled to a PLC in accordance with aspects of the invention. As shown in FIG. 4, the assembly is mounted on a silicon breadboard or platform 410. The assembly includes a PLC 420 having a multiplexer and demultiplexer for combining and splitting optical signals. In some embodiments, the multiplexer and demultiplexer are etched gratings fabricated in silicon-on-insulator (SOI), or AWGs fabricated with silica on silicon technology. The PLC includes multiplexer input waveguides 430 on one side, and a single multiplexer output waveguide (not shown) on the other side.

In the example in FIG. 4, there are four lasers 460 soldered on to the silicon breadboard 10. Each laser may have a different wavelength, where the wavelength is matched to that of the input waveguide of the PLC. The diverging light from each laser, for example a full width at half maximum of 20 degrees in the horizontal and 30 degrees in the vertical may be refocused by a ball lens 450 into the multiplex input waveguide of the PLC.

The ball lens 450 may be fit into a holder etched out of silicon breadboard material. This holder is initially free to move in all three dimensions. There is a handle 490 at the end of this holder that may be manipulated in all three axes. The other side of the holder may be fixed in the silicon breadboard 410 and cannot move. Between the ball lens and the fixed end of the holder there is a spring or flexture 440 that is made of thinner silicon in a zig-zag structure, allowing it to stretch slightly and bend up and down. As the handle 490 is manipulated up and down, the lens on the holder also moves up and down. The entire spring/lens/holder assembly may be a lever, where the lens is placed much closer to the pivot point. This causes a mechanical demagnification, such that a large motion of the handle causes a smaller motion of the lens.

The handle may include a small metalized pad 485 and two thick depositions of solder on either side of a holder 480. There is electrical contact by way of metallization between the two deposited solder regions such that the application of electrical current between the solder pads causes localized heating and the solder to melt and lock the handle in position. Once the lasers, the PLC and lenses have been loaded on to the stage, the lasers are activated, and the holder 480 is adjusted to maximize the optical coupling to the PLC. At an acceptable optical coupling, and preferably optimum optical coupling, electrical current is applied to the solder pads, and the solder flows to a position to lock the holder in position. Optical coupling may be evaluated by determining optical output of the PLC, which may be performed for example measuring optical power using an optical power meter or other device.

Once the system is aligned, a high speed driver IC 470 may be mounted on top of the assembly, although in some embodiments the high speed driver IC is mounted prior to system alignment. In many embodiments, however, the high speed diver IC is mounted to circuit board discussed with respect to FIG. 1 and/or 2. This IC would be wire-bonded to the lasers and to the silicon breadboard. There are also electrical interconnects 495 on the silicon breadboard that take both low speed and high speed signals from the periphery of the chip to the driver IC and lasers. The output of the PLC is not shown, but such is coupled to a fiber.

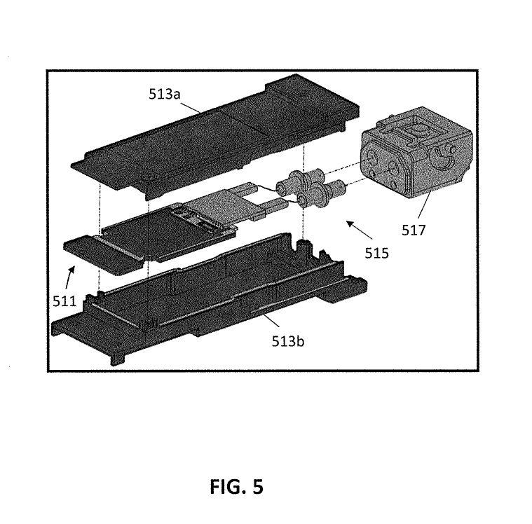

FIG. 5 shows an exploded view of an optical transceiver in accordance with aspects of the invention. The optical transceiver includes electro-optical components 511 in a housing having a top part 513a and a bottom part 513b. As with the embodiment of FIG. 1, and as further discussed below, the electro-optical components include a circuit board, electro-optical conversion elements (e.g. lasers and photodiodes) and associated circuitry (e.g. transimpedance amplifiers) on a substrate mounted to the circuit board, and light routing elements (e.g. a PLC, capillary structures, and fiber pigtails). The electro-optical components are within a common volume of the housing, although in some embodiments only some components, for example the electro-optical conversions elements, may be wholly within the common volume.

Receptacles 515 are coupled to the electro-optical components of the housing, for example by way of fiber pigtails, with the receptacles extending through apertures in the housing. The receptacles also extend into a case front 517 of the optical transceiver.

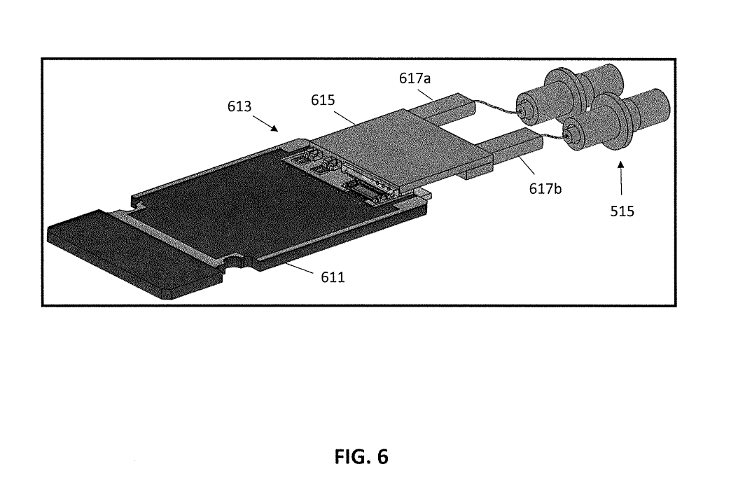

FIG. 6 shows portions of the optical transceiver of FIG. 5. As shown in FIG. 6, a circuit board 611 includes a forward end 613 upon which a substrate is mounted. Electro-optical conversion elements and some associated circuitry are on the substrate. A PLC 615 is in front of the electro-optical conversion elements, with the PLC routing light from and to capillary structures 617a, 617b. The capillary structures are optically coupled to the receptacles 515, for example by fiber pigtails.

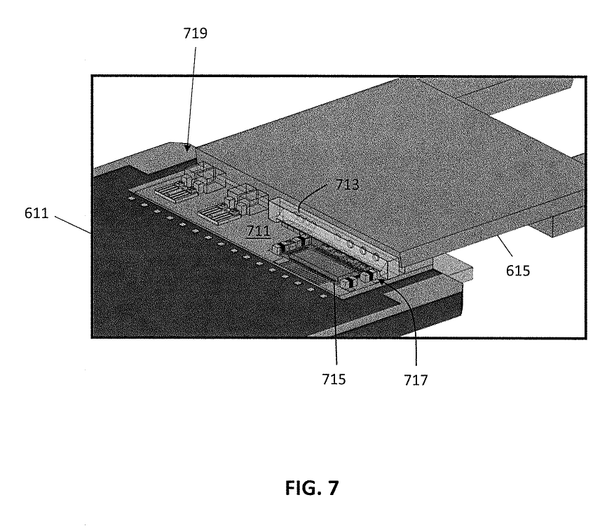

FIG. 7 shows a close up perspective view of some of the components of the optical transceiver of FIG. 5. FIG. 7, like FIG. 6, shows the circuit board 611, with the substrate 711 mounted on a forward end of the circuit board. The PLC 615 is mounted, on a spacer on the substrate, at a front of the substrate. Optics, in the form of a folding optic structure 713, is along part of a rear edge of the PLC. The folding optic structure includes lenses, in some embodiments, positioned along the rear edge of the PLC, to focus light from the PLC towards an angled mirror of the folding optic structure. The angled mirror reflects light from the PLC down towards the substrate. In the embodiment of FIG. 7, waveguides of the PLC are generally towards what may be considered a bottom of the PLC, namely a side of the PLC parallel to and closest to the submount.

A plurality of photodetectors 717, for example photodiodes, are positioned on the substrate to receive light from the PLC reflected by the mirror. The photodetectors are diebonded on the substrate in many embodiments. The photodetectors are electrically coupled to a transimpedance amplifiers on a chip 715 on the substrate. The transimpedance amplifier chip may also be diebonded on the substrate.

Portions of an optical transmit chain 719 is also mounted on the substrate. For example, the portions of the optical transmit chain may include lasers which provide light to optical isolators, with the optical isolators positioned to pass light into the PLC. In some embodiments laser driver circuitry, for directly modulating the lasers, is also mounted to the substrate proximate the lasers. In various embodiments, a MEMs structure, for example include a lens on a moveable stage, may be used to pass light from the lasers to the optical isolators. In some embodiments the MEMS structure is for example as discussed in the afore-mentioned U.S. patent application Ser. No. 14/621,273 filed on Feb. 12, 2015 entitled PLANAR LIGHTWAVE CIRCUIT ACTIVE CONNECTOR, and/or U.S. Pat. No. 8,346,037 issued on Jan. 1, 2013 entitled MICROMECHANICALLY ALIGNED OPTICAL ASSEMBLY, the disclosures of which were, and are, incorporated herein by reference for all purposes. In some embodiments, a MEMs structure may also be provided for directing light reflected from the angled mirror to the photodetectors.

In addition, although not shown in FIG. 7, in many embodiments the PLC includes light paths for returning some of the light generated by the lasers back towards the substrate. In such embodiments, monitor photodetectors may be mounted on the substrate to provide for monitoring of output light levels, for example through use of circuitry coupled to the laser drivers or other circuitry on the circuit board.

In some embodiments the transimpedance amplifier chip, the lasers, monitor photodetectors, photodetectors, MEMs structure and optical isolators are all diebonded on the substrate. The lasers may then be provided electrical connections using wirebonds, with the PLC and folding optic structure thereafter attached. MEMs alignment, if a MEMs structure is used, and alignment of the folding optic structure, if necessary, may then be performed.

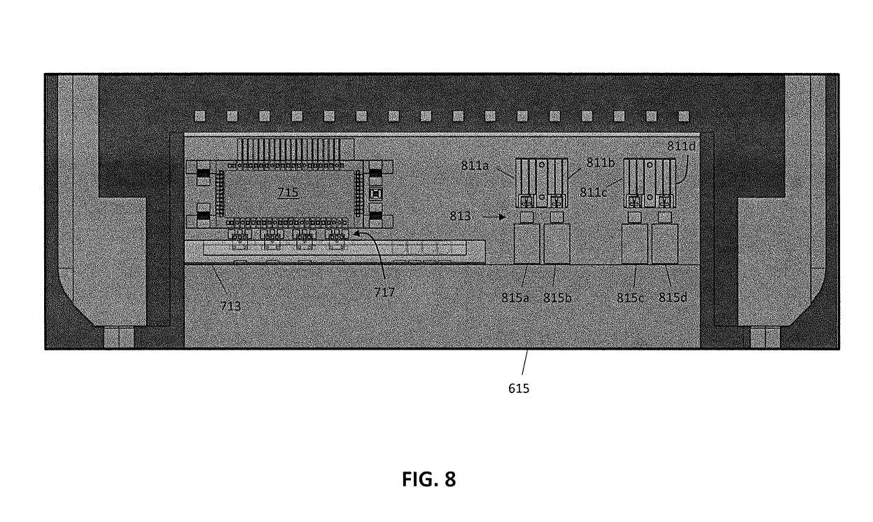

FIG. 8 shows a close up top view of some of the components of the optical transceiver of FIG. 5. More particularly, FIG. 8 shows items mounted on the submount about a rear edge of the PLC 615.

As may be seen in FIG. 8, the folding optic structure 713 abuts the rear edge of the PLC. Photodetectors 717, generally high speed photodetectors, are on the submount and positioned to receive light from the PLC as directed by the folding optic structure. In the embodiment shown in FIG. 8, the photodetectors are partially between the folding optic structure and the submount. The photodetectors are electrically coupled to the TIA chip 715, to allow for amplification of signals generated by the photodetectors in response to received light from the PLC.

The lasers and the optical isolators of the transmit chain are also visible in FIG. 8. In the embodiment shown, four laser carriers 811a, 811b, 811c, and 811d are on the submount.

Each of the laser carriers includes one laser, although in various embodiments each laser carrier may carry an array of lasers, with for example each array including four (or fewer or more) lasers. The lasers on the laser carriers 811a, 811b, 811c, and 811d are positioned to provide light to optical isolators 815a, 815b, 815c, and 815d, respectively. The optical isolators are shown as abutting the rear edge of the PLC, and are positioned so as to pass light to waveguides of the PLC. In this regard, FIG. 8 shows lensing elements 813 between the lasers and the optical isolators. The lensing elements are part of MEMs structures (not shown in FIG. 8), providing for optical alignment with the optical isolators/PLC.

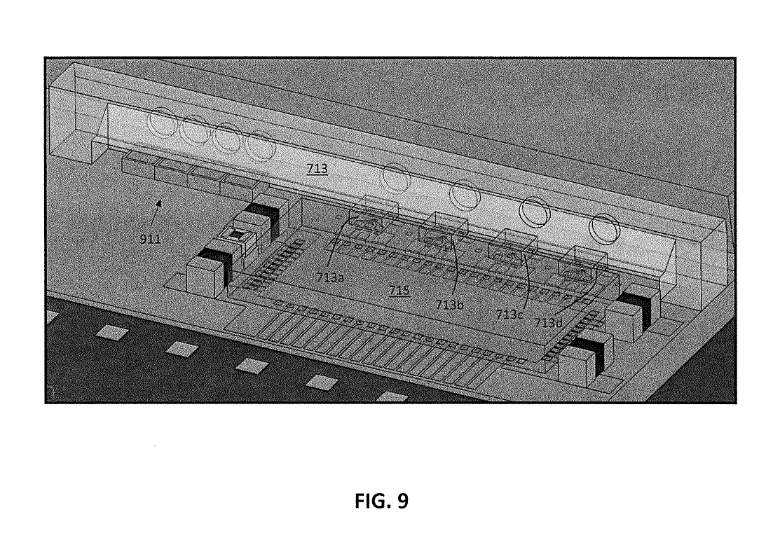

FIG. 9 shows a further view of some of the components of the optical transceiver of FIG. 5. FIG. 9 illustrates photodetectors 713a, 713b, 713c, and 713d on the submount, with the photodetectors positioned under an angled mirror of the folding optics structure 713. The TIA chip 715, shown in phantom, is also visible, with the TIA chip shown to the rear of the photodetectors.

Monitor photodetectors 911 are also visible in FIG. 9. The monitor photodetectors are also positioned under the folding optics structure, so as to receive light from further waveguides of the PLC. The further waveguides generally feedback to the monitor photodetectors light from the lasers which was passed into the PLC. The monitor photodetectors may be used to adjust laser intensity, for example.

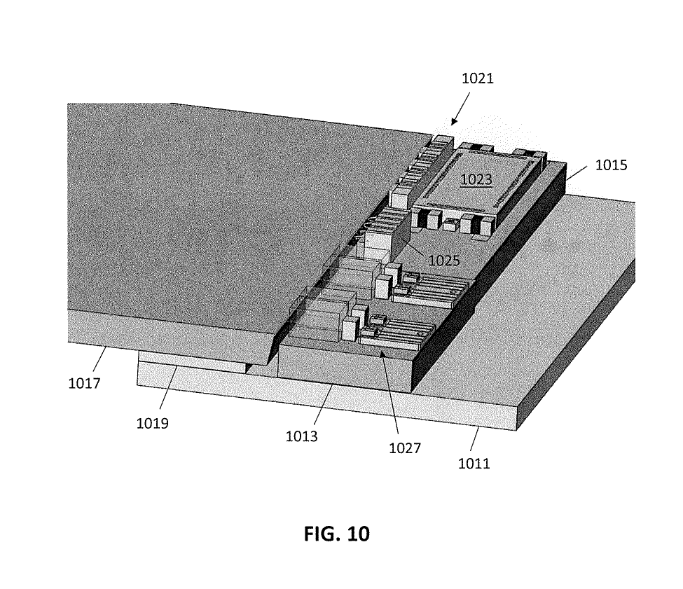

FIG. 10 shows portions of a further optical transceiver in accordance with aspects of the invention. The portions of the further optical transceiver shown in FIG. 10 includes a circuit board 1011 (conceptually illustrated), with a first submount 1013 and a second submount 1015 on the circuit board. In some embodiments the first submount is generally used for transmit chain elements, while the second submount is generally used for receive chain elements. In some embodiments the first submount is generally used for potentially lower yield elements, for example laser elements, and the second submount is used for potentially higher yield elements, for example photodetectors and a transimpedance chip. The use of two separate submounts is useful in increasing manufacturing yields, among other reasons, as a failure of a single component found during manufacturing tests would not affect both submounts.

In the embodiment of FIG. 10, a PLC 1017 is positioned on a spacer 1019 on the circuit board. Compared to the embodiment of for example FIG. 7, the PLC of FIG. 10 could be considered “flipped,” in that a side of the PLC with waveguides would be a side of the PLC parallel to and away from the circuit board.

Photodetectors 1021 are mounted on the second submount. The photodetectors are mounted in what may considered a “tombstone” configuration, with an optically sensitive portion (normally facing away from the circuit board) facing the PLC and metal connections (normally facing the circuit board) on an opposing side. The photodetectors therefore may receive light directly from the PLC, although in some embodiments additional optical elements may be used to direct the light to the photodetectors, with lenses positioned between the PLC and photodetectors in some embodiments. Wraparound metal, for example, may be used to connect the metal connections of the photodetectors to the circuit board.

Electrical signals from the photodetectors are provided to transimpedance amplifiers on a TIA chip 1023, also mounted on the second submount. As shown in FIG. 10, monitor photodetectors 1025 are also on the second submount. Like the photodetectors 1021, the monitor photodetectors are mounted in a tombstone configuration.

Laser carriers 1027 are mounted on the second submount. The laser carriers each carry a laser, although in some embodiments each laser carrier may carry a plurality of lasers, for example arranged as an array of lasers. The lasers provide light to the PLC. Associated optical elements, such as lenses and optical isolators, may also be mounted to the second submount, to assist in directing light to the PLC and/or to modify optical properties of the light.

The two submounts may be of the same thickness, or may be of different thicknesses. The use of the two submounts therefore allows for separate optimization of photodetector heights with respect to the PLC and laser heights with respect to the PLC.

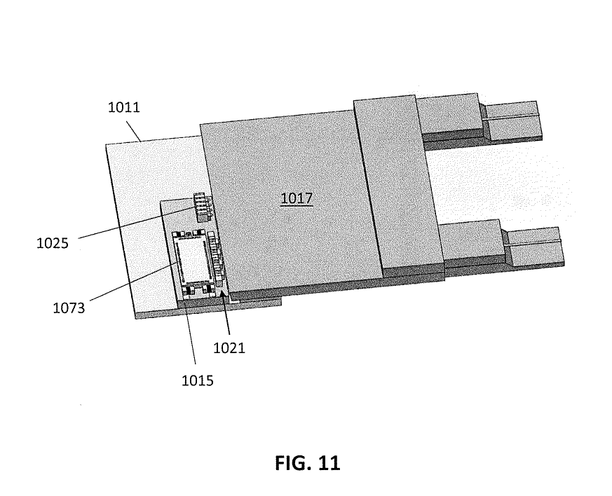

FIG. 11 shows portions of the further optical transceiver of FIG. 10, with the first submount 1015 installed on the circuit board 1011. The first submount is mounted about the rear edge of the PLC 1017. High speed photodetectors 1021 are on the first submount about the rear edge of the PLC, to receive light from the PLC. A TIA chip 1073, with transimpedance amplifiers, is mounted on the first submount proximate and behind the photodetectors 1021. The transimpedance amplifiers provide an amplified voltage signal based on a current signal provided by the photodetectors, in most embodiments. Monitor photodetectors 1025 are also shown on the first submount, also about the rear edge of the PLC, with the monitor photodetectors arranged generally linearly with the high speed photodetectors.

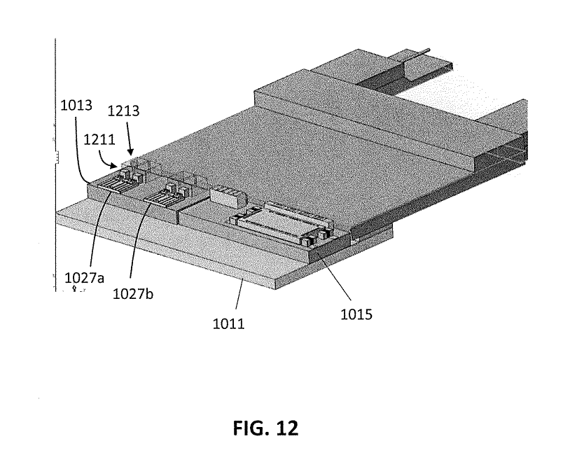

FIG. 12 shows portions of the further optical transceiver of FIG. 10, with the first submount 1015 installed and the second submount 1013 installed on the circuit board 1011. A first laser carrier 1027a and a second laser carrier 1027b are on the second submount. In the embodiments of FIG. 10, each of the laser carriers carry two lasers. In most embodiments the lasers are directly modulated with data, for example by laser drive circuitry (not shown). Light from the lasers passes through optical isolators 1213 and into the rear edge of the PLC, or more completely into waveguides of the PLC. MEMs structures 1211 (conceptually shown) are provided between the lasers and the optical isolators, allowing for directional alignment of light from the lasers into the optical isolators/waveguides of the PLC.

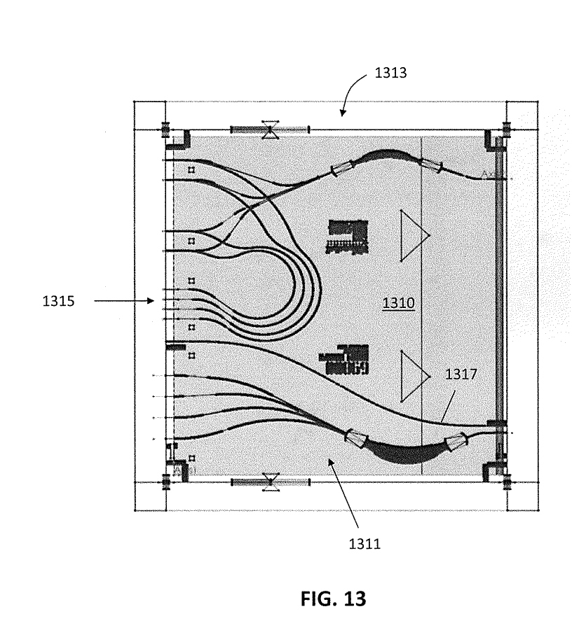

FIG. 13 schematically shows a layout of a further PLC useful in aspects of the invention. The layout of the PLC of FIG. 13 may be used in some embodiments for the PLC discussed elsewhere herein.

The PLC of FIG. 13 includes a substrate 1310 with an optical demultiplexer 1311 and an optical multiplexer 1313. The optical demultiplexer may receive light in a single input waveguide at a first edge of the PLC, and provide demultiplexed light at an opposing second edge of the PLC, in four output waveguides as illustrated in FIG. 13. In many embodiments, the second edge of the PLC corresponds to a rear edge of the PLC of various embodiments discussed herein. In most embodiments the single input waveguide receives light carrying data signals at a plurality of wavelengths (four wavelengths for the embodiment of FIG. 13), and demultiplexes the light, on a wavelength selective basis, into the four output waveguides. The four output waveguides may provide the light carrying the data to the high speed photodetectors, for example. In various embodiments the demultiplexing function is performed by an arrayed waveguide grating (AWG) of the optical demuliplexer.

Similarly, the optical multiplexer may receive light at the second edge of the PLC, in four input waveguides as illustrated in FIG. 13, and provide multiplexed light in a single output waveguide at the first edge of the PLC. In most embodiments the four input waveguide each receive light carrying data signals at a plurality of wavelengths (four wavelengths for the embodiment of FIG. 13), and multiplexes the light into the single output waveguide. The light carrying data may be provided by lasers, such as discussed elsewhere herein. In various embodiments the multiplexing function is performed by an arrayed waveguide grating (AWG) of the optical multiplexer.

In addition, monitor waveguides 1315 branch off the input waveguides, with each of the monitor waveguides receiving some light, generally a known (small) percentage of the light, passing through the input waveguides. The monitor waveguides extend from their respective branching points with the first input waveguides and extend to the second edge of the PLC. In most embodiments light output from the monitor waveguides is received by the monitor photodiodes.

In some embodiments an additional waveguide(s) 1317 is also provided between the first and second edges of the PLC.

Although the invention has been discussed with respect to various embodiments, it should be recognized that the invention comprises the novel and non-obvious claims supported by this disclosure.

1. An optical transceiver assembly, comprising:
a substrate;
a circuit board fixedly coupled to the substrate and configured to process and provide electrical signals;
a plurality of lasers on a submount on the circuit board, the plurality of lasers configured to generate light in accordance with at least some of the electrical signals;
a planar lightwave circuit (PLC) fixedly coupled to the substrate, the PLC including an optical demultiplexer having an input and a plurality of outputs and an optical multiplexer having a plurality of inputs to receive the light from the lasers and an output; and
an input optical fiber coupled to the input of the optical demultiplexer of the PLC and an output optical fiber coupled to the output of the optical multiplexer of the PLC.

2. The optical transceiver assembly of claim 1, wherein the substrate is a metal plate.

3. The optical transceiver assembly of claim 1, wherein the circuit board includes a clock and data recovery (CDR) chip and a driver chip mounted thereon.

4. The optical transceiver assembly of claim 1, wherein the lasers are configured to generate modulated light in accordance with at least some of the electrical signals.

5. The optical transceiver assembly of claim 1 further comprising photodetectors configured to receive light from the PLC and generate electrical signals to be provided to circuitry of the circuit board.

6. The optical transceiver assembly of claim 1, wherein the optical multiplexer and the optical demultiplexer each include arrayed waveguide gratings (AWGs).

7. The optical transceiver assembly of claim 1, wherein the input optical fiber and the output optical fiber are fiber pigtails.

8. The optical transceiver assembly of claim 7, wherein the fiber pigtails are each coupled to the PLC by a corresponding capillary assembly.

9. The optical transceiver assembly of claim 7, wherein the fiber pigtails each couple the PLC and a receptacle at a front of the optical transceiver assembly.

10. The optical transceiver assembly of claim 9, wherein the fiber pigtails have a length greater than a length sufficient to allow for connection between the corresponding capillary assemblies and the receptacle so as to provide mechanical compliance between the receptacle and the PLC.

11. The optical transceiver assembly of claim 1, further comprising a plurality of photodetectors positioned to receive light from the plurality of outputs of the optical demultiplexer of the PLC.

12. The optical transceiver assembly of claim 11, wherein the plurality of photodetectors are mounted to the submount.

13. The optical transceiver of claim 12, wherein the submount and the circuit board are in a common housing.

14. The optical transceiver assembly of claim 12, wherein the submount and the circuit board share a common undivided volume in the common housing.

15. The optical transceiver assembly of claim 11, wherein the plurality of lasers are mounted on a first submount and the plurality of photodetectors are mounted to a second submount.

16. The optical transceiver of claim 15, wherein the first submount, the second submount, and the circuit board are in a common housing.

17. The optical transceiver assembly of claim 15, wherein the first submount, the second submount, and the circuit board share a common undivided volume in the common housing.

18. The optical transceiver assembly of claim 1, wherein the plurality of lasers are mounted on a further substrate mounted on a forward end of the circuit board.

19. The optical transceiver assembly of claim 18, wherein the PLC is mounted on a spacer at a front of the further substrate.

20. The optical transceiver assembly of claim 19, further comprising a folding optics structure to direct light from the PLC towards the further substrate.

21. The optical transceiver assembly of claim 20, further comprising photodetectors coupled to the further substrate, and wherein the folding optics structure directs light from the PLC to the photodetectors.

22. The optical transceiver assembly of claim 21, further comprising a transimpedance amplifier (TIA) chip mounted on the further substrate, with the photodetectors electrically coupled to the TIA chip.

23. The optical transceiver assembly of claim 20, wherein the folding optics structure comprises an angled mirror to reflect light from the PLC towards the further substrate.

24. The optical transceiver assembly of claim 18, further comprising a MEMs structure, carrying lenses on at least one moveable stage to pass light to the PLC, the MEMs structure being coupled to the further substrate.
